(19) United States
(12) Patent Application Publication
(10) Pub. No.: US 2022/0027833 A1
(43) Pub. Date: Jan. 27, 2022

(54) METHOD AND SYSTEM FOR AUTOMATIC RECOMMENDATION OF WORK ITEMS ALLOCATION IN AN ORGANIZATION

(71) Applicant: DEEPCODING LTD., Tel Aviv (IL)

(72) Inventors: Oren MIARA, Tel Aviv (IL); Arnon YAFFE, Tel Aviv (IL); Gadi WOLFMAN, Tel Aviv (IL)

(73) Assignee: DEEPCODING LTD., Tel Aviv (IL)

(21) Appl. No.: 17/382,763

(22) Filed: Jul. 22, 2021

Related U.S. Application Data
(60) Provisional application No. 63/054,892, filed on Jul. 22, 2020.

(51) Int. Cl. G06Q 10/06; G06F 40/40

(52) U.S. Cl. CPC G06Q 10/063112; G06F 40/40; G06Q 10/06312; G06Q 10/06315

(57) ABSTRACT

A system and a method of automatically allocating by an autonomous orchestration of work items to organizational resource are provided herein. The method may include the following steps: obtaining a stream of work items allocation requests from a delivery management system; analyzing the stream of work items allocation requests, to extract work items specification from the requests; applying an optimization of the human resources vis a vis the work items specifications; and providing recommendation for allocation of said work items to the delivery management system.

### CROSS REFERENCE TO RELATED APPLICATIONS

This application claims the benefit of U.S. Provisional Patent Application No. 63/054,892, filed Jul. 22, 2020, which is incorporated herein by reference in its entirety.

### FIELD OF THE INVENTION

The present invention relates generally to the field of automatic processing of organizational workflows and a recommendation engine for work item allocation therein.

### BACKGROUND OF THE INVENTION

One of the challenges in modern Service and Support operations (such as IT, Customer Service, HR) is how would it best to allocate a new work item (often called a ticket) to the best agent or resolver given the nature of the work item, the skillset of the agents and the availability or workload of the human resources in the organization.

Currently, Service and Support operations are using various Delivery Management Software (DMS) to manage digitally deliverable items e.g., tickets, tasks, incidents, service requests, change requests, and the like, all of which are referred hereinafter as “work items”.

Although the work items exhibit some form of specificity depending on whether it is an incident, a service request, or a task as part of a project, one thing that is common to all these work items, is that they are deliverables items that have an assignee who is responsible for the delivery of the totality or part of the work item. It should be noted that an assignee can be either a human or a robot, or a group thereof.

Currently available DMS solutions include software packs by: ServiceNow, Salesforce, WorkDay, Monday.com, Microfocus, Atlassian, B M C, and Broadcom, which are offering both on-premises and on cloud computing platforms (SaaS/PaaS).

Recommending the most suitable assignee with the highest chance to deliver part or the entire work items successfully (e.g., delivery on time and on quality) is very hard to automate because employees come and go, they have different skill sets and one or several employees could fit, they have different availabilities, and new kinds of work items may appear in the future, and their workload may vary depending on the size of their respective work item queue.

Therefore, automating the allocation of work items (autonomous Orchestration of work items) can potentially save a lot of management time, reduce waste due to wait time, prevent wrong allocation of work items, increase quality and accelerate the overall performance of delivery teams by reducing the Average Handling Time of the work items.

### SUMMARY OF THE INVENTION

According to some embodiments of the present invention, a method and system for recommending work items allocation in an organization are provided herein. The method may include receiving a stream of work items allocation requests, analyzing the stream of work items allocation requests using an extractor module that may use natural language processing or non-natural language analysis, to extract work items specification from the requests; applying an optimization of the human resources and/or robotic resources vis à vis the work items specifications; and providing recommendation for allocation. Optionally, the method may also include implementing the recommendations in real time on the delivery management system software of the organization by automatically changing the “Assignee” field within the work item using an application programming interface (API) or other synchronization method.

Advantageously, embodiments of the present invention provide a combination of three elements: understanding the tickets, automatically building a skillset mapping of all the agents and automatically building a real time workload mapping so it is possible to avoid bottlenecks in the routing and in constantly monitoring for new bottlenecks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a server for automatic recommendation of work items allocation in an organization, in accordance with embodiments of the present invention; and

FIG. 2 is a high-level flowchart illustrating a method in accordance with embodiments of the present invention; and

FIG. 3 is a high-level flowchart illustrating another non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

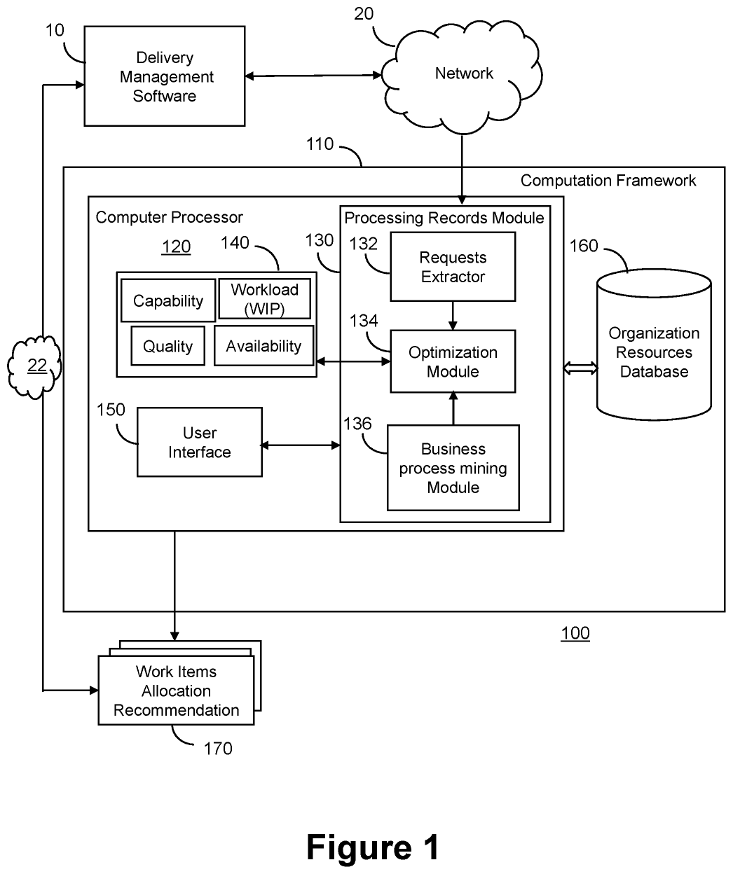

FIG. 1 is a block diagram illustrating non-limiting exemplary architecture of a server for automatic allocation of organizational resources to incoming work items, in accordance with embodiments of the present invention.

System 100 may include a server or computation framework 110 connected to a delivery management system (DMS) 10 via networks 20 or 22. For simplicity the term “Server”, is used herein although the computation framework can be composed of multiple virtual servers in a Datacenter or cloud computation provider (such as Azure, AWS, GCS). Server 110 may include a processing records module 130 implemented on computer processor 120 and may include a request extractor 132, an optimization module 134, and a business mining module 136.

Server 110 may also include an organization resources database 160 which holds all available resources of the organization (e.g., employees or agents).

Server 110 may also hold optimization parameters 140 which are attributes associated with the organization resources. These may include quality (score), workload including work in process (WIP), ability (or capability) and availability.

According to some embodiments of the present invention, business mining module 136 may further study the history of task transfer and generate a model based on history. This is also advantageous for assessing the skill set needed for each task.

In operation, processing records module 130 obtains a stream of requests from the DMS using requests extractor 132. Then, using optimization module 134 and based on optimization attributes 140, and further based on input from business process mining module 136 which interacts with organization resources database 160, processing records module 130 may provide work items allocation recommendation 170.

According to some embodiments of the present invention, work items allocation recommendation 170 may be applied to a delivery management system (DMS) 10 for improving the efficiency of resource allocation in the organization. The recommendations can be either as a set of instructions to the DMS software or can be presented over a user interface to human reviewers such as group managers who can benefit from understanding ways to improve the workflow of the organization.

According to some embodiments of the present invention, all work items communications in an organization provided over a delivery management system (DMS) may have a textual description field such as “short description”, “long description”, “notes”, and “resolution” which describes what needs to be done in natural human language or any other language. The text can be within unstructured attachments (e.g., MS word document) which are targeted to natural language processing (NLP).

Therefore, it is suggested by inventors of the present invention that the extracting of the essential requirements from text may be carried out by a mechanism that eliminates, based on the context, whether certain data is considered general or organization-oriented and based on this analysis, the relevance of the data for work item allocation can be determined.

According to some embodiments of the present invention, the aforementioned process may preserve the work items specifications that are required for allocating to the most efficient resource in the organization, given various constraints.

Subsequently, according to some embodiments of the present invention, a process of augmentation may be carried out by timely based self-joining the data, on both the textual features and the embedding feature transformed from the textual features. The embedding mechanism may ensure that highly related descriptions by semantics can also be related to each other by means of closeness in high dimensional representation.

According to some embodiments of the present invention, the output then is a tabular representation of the data with two main columns, the textual description and array of potentially adequate employee identification.

According to some embodiments of the present invention, yet another important factor may be the scoring of the person (employee, a team of employees or even a robot). The scoring of a person in terms of skills and ability to carry out the work item effectively may be implemented in a manner like the one described in detail by U.S. patent Ser. No. 10/423,916 which is incorporated herein by reference in its entirety.

According to some embodiments of the present invention, optimizing the probability for a given feature set to be more likely to fall into the right class may be mostly carried out by optimizing the SoftMax cross-entropy loss equation. A SoftMax function assumes only one adequate class. For example, when the system predicts a who resolved a work item. Although most work items have more than one adequate resolver at any point in time for a given work item.

For example, IT administrators can work in shifts and can resolve a variety of work items that come from different customers on different resources, when trying to optimize the SoftMax cross entropy loss it is possible to map f(x)→y, where x denotes the features and y represents the adequate resolver (employee or robot).

According to some embodiments of the present invention, an exemplary mathematical representation of the optimization process may reveal that original features (x) elicited from the original system of work item suffers from un-convergence when trying to optimize.

The following is mathematical formulation of the optimization constraints of work items allocation, wherein “ce” denotes “cross entropy loss function”:

f′(x)=f′(ce(SoftMax(model(x)))=f′(ce(SoftMax(y′))|where x represents the features, y′ represents the output of the model.

Optimize→f′(x)=f′(ce(SoftMax(model(x1))) where y equal y1

Optimize→f′(x)=f′(ce(softmax(model(x2))) where y equal y2 Equation (1)

The problem then arises when x1=x2 and y1≠y2.

When optimizing the model, a solution for W/b (weights and biases) is searched so they can support the assumption that x1→y1 and x2→y2 the problem with convergence applies here.

### Equation (2)

According to some embodiments of the present invention, transforming the data so that it would overcome the problem in (1) is done by relabeling the resolver column.

Feature x is the textual representation of the work item. The process than goes on to find the similarity between incidents by processing various metrics. x1 and x2 are two different textual representation of work item #1 and work item #2. Semantically they are the same. For example:

```
x1 : Dear <name1>,
    i'm suffering from an incredibly slow internet on my laptop,
    please fix it asap!
    best regards <name2>
    y1
x2 : wifi is slow on my hp laptop
    y2
    . . .
xn : wifi is slow on my hp laptop
    y3
```

After projecting x1, x2 to coordinates in a high dimensional space it is desirable that these two work items to be highly correlated. Thus, when Equation (2) is applied, it is equivalent to say that resolvers of x1 and x2 . . . xn are skilled to resolve all of them.

According to some embodiments of the present invention, the input provided by said human used comprise reordering these stages.

Once the various resolvers are found, the recommendation to use each of them is based on other metrics such as availability, cost, and assignment of other tasks (prioritization).

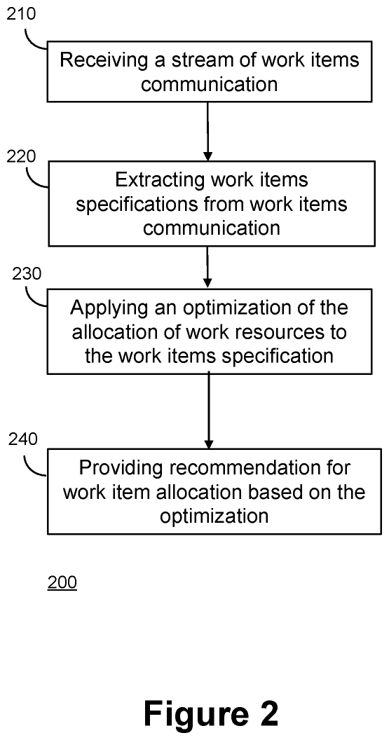

FIG. 2 is a high-level flowchart illustrating non-limiting exemplary method in accordance with embodiments of the present invention. Method 200 may include the following steps: receiving a stream of work items allocation requests 210, analyzing the stream of work items allocation requests, to extract work items specification from the requests 220; applying an optimization of the human resources vis a vis the work items specifications 230, and providing recommendation for allocation 240.

In accordance with some embodiments of the present invention, it is important to assess or calculate work in process (WIP) of the various organizational resources when assessing availability and workload of the various groups or teams of employees (or robots in case of non-human resources). The WIP (number of tickets in process) can be obtained by tracking and counting the stream of working items and the change in the status of the items (items that were resolved and being closed, items that were opened or reopened etc.)

Cycle time can be obtained from historical measurements resolution of ticket from the same type and/or calculation with the following formula (1)

$$Cycle Time = \frac{WIP}{Throughput} \qquad Formula ( 1 )$$

Wherein Cycle Time=WIP/Throughput. The throughput is determined by the counting of resolved tickets in last x hours. Additional metric that can be used in embodiment of this patent is the catchup ratio. The catchup ratio is defined by dividing the count of resolved tickets in count of added tickets (in last x hours) and factored in when assessing the ability/capability of the resources.

In some embodiments, illustrating a practical work items allocation for groups, the following definitions may apply:
Calculate “Transfers from tickets” for each group, by counting distinct tickets that were transferred from each group in the organization in in last 24 hours
Calculate “New tickets” for each group, by counting distinct tickets that were opened (or re-opened) within last 24 hours.
Calculate “Transfers to tickets” for each group, by counting distinct tickets that were transferred to this group in last 24 hours

Calculate “Resolved tickets” per group by counting the number of tickets that their status was changed to Resolved/Closed/Cancel 24 hours. With the above calculated Catch-up Ratio (Resolved+Transfers to)/(New+Transfers from).

In some embodiments of this patent, each group can have a pre-defined SLA (e.g., number of unresolved tickets in its queue) and SLA breach can be a criterion for re-allocation of tickets.

When looking at tickets' assignment re-allocation/optimization in some embodiment of the patent, need to take into account which tickets can be transferred between groups, and which are not. We use the term “transferable tickets” for tickets that can be handled by other groups (e.g. there is no geographical limitation, there are no specific skills of individuals in specific group etc.).

In a Non-limiting example below, the following are three groups of persons/agents showing the number of tickets in WIP and Capacity and also the capability of each person in parentheses, for example, Network or Printers. Also shown is the Backlog and incident identifiers (ID1, ID2, ID3 etc.)

Group A—Current WIP (1), Capacity (4)
Mor (Network)
Karen (Network)
David (Network)
Rose (Network)

Group B—Current WIP (1), Capacity (3)
Dan (Network)
Ruth (Network)
Donald (Network)

Group C—Current WIP (3)
Backlog—Printers(4): ID1, ID2, ID3, ID4, Network(4): ID5, ID6, ID7, ID8
Capacity(3)
Moshe (Printers)
John (Network, Printers)
Iris (Network, Printers)

The Steam of new incidents is shown below with an accompanying text that need extraction and classification:

Stream—New Incidents 3
ID9—“Cannot print—I think tray is empty”
ID10—“Zoom hangs in the last 1 hour”
ID11—“I get a message that no network connection is available”

The next step is extracting and classifying the task to the capacity or type of resource:

Classification
ID9—“Cannot print—I think tray is empty”->Printers
ID10—“Zoom hangs in the last 1 hour”->Network
ID11—“I get a message that no network connection is available”->Network

The next step is to assess and determine which of the new incidents (tickets) are transferable:

Transferable Tickets:
ID5, ID6, ID7, ID8

New Tickets Printers:
ID9

New Tickets Network:
ID10
ID11

Network:

### ID5, ID6, ID7, ID8, ID10, ID11

Printers:
ID1, ID3, ID3, ID4, ID9

The next step is to optimize the allocation and determine which of the new incidents (tickets) are transferable:

Allocate to Group A:

ID5, ID6, ID7

Allocate Group B:

ID8, ID10, ID11

Allocate Group C:

ID1 (the rest are already in this group backlog)

In accordance with some embodiments of the present invention, instead of textual description as in the above example, the extraction can also be of audio description.

In accordance with some embodiments of the present invention, the system may operate in real time mode so that the allocation of the work items is carried out as soon as new items arrive.

According to some embodiments of the present invention, there may be hierarchy in tickets, for example: parent “Service Request’ can be composed of multiple “Service Request Tasks”.

According to some embodiments of the present invention, when allocating/transferring/assigning/evaluating-per-skill a ticket, the entire list of sub-tickets may be taken into account, to provide the full picture factored in.

According to some embodiments of the present invention, the logic of the optimization can be configurable via the user interface. Configuration can be determined and further improved overtime. For example, how to balance the different factors for allocation (capacity, workload, availability, skill sets match) can be configured (e.g., weighted average).

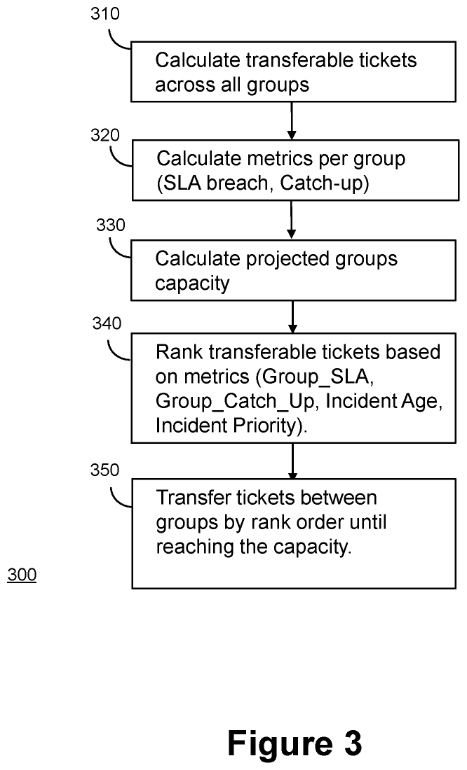

FIG. 3 is a high-level flowchart illustrating the usage of aforementioned non-limiting exemplary definitions in a practical work items automatic allocation in accordance with embodiments of the present invention. Method 300 may include the following steps: Calculate transferable tickets across all groups 310; Calculate metrics per group (e.g., SLA breach, Catch-up) 320; Calculate projected groups capacity 330; Rank transferable tickets based on metrics (e.g., Group_SLA, Group_Catch_Up, Incident Age, Incident Priority) 340; and Transfer tickets between groups by rank order until reaching the capacity 350.

It should be noted that methods 200 and 300 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures, and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that element.

It is to be understood that where the specification states that a component, feature, structure, or characteristic “may”, “might”, “can” or “could” be included, that component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or like those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of automatically optimizing work item allocation to organizational resources using a computerized delivery management system (DMS), the method comprising:
obtaining a stream of work items allocation requests from the DMS;
analyzing the stream of work items allocation requests, to extract work items specification from the requests;
applying an optimization of the organizational resources in view of the work items specifications; and
providing recommendation for allocation or performing automatic allocation of said work items at the DMS.

2. The method according to claim 1, wherein said organizational resources comprise at least one of: a human, a team of humans, one or more robots, and a hybrid team comprising at least one human and at least one robot.

3. The method according to claim 1, wherein said stream of work items allocation requests further comprises at least one of: ticketing system documents, emails, messages, sent between the organizational resources.

4. The method according to claim 1, wherein extracting the work item specification is carried out by applying natural language processing and/or rules.

5. The method according to claim 1, wherein the applying of said optimization factors in at least one of: capacity, scoring, workload, and availability of said organizational resources.

6. The method according to claim 5, wherein the scoring is calculated by assessing the performance of the organizational resource by monitoring a behavior thereof.

7. The method according to claim 5, wherein the workload is calculated by assessing the work in process of the organizational resource by monitoring a behavior thereof.

8. A system for automatically optimizing work item allocation to organizational resources using a computerized delivery management system (DMS), the system comprising:
a request extractor configured to obtain a stream of work items allocation requests from the DMS;
a business process mining module configured to analyze the stream of work items allocation requests, to extract work items specification from the requests; and
an optimization module applying an optimization of the organizational resources in view of the work items specifications,
wherein the system is configured to provide recommendation for allocation or performing automatic allocation of said work items to the DMS, and
wherein the request extractor, the business process mining module, optimization module are implemented by sets of instructions executable on a computer processor.

9. The system according to claim 8, wherein said organizational resources comprise at least one of: a human, a team of humans, one or more robots.

10. The system according to claim 8, wherein said stream of work items allocation requests comprises at least one of: documents, emails, messages, sent between the organizational resources.

11. The system according to claim 8, wherein extracting the work item specification is carried out by applying natural language processing.

12. The system according to claim 8, wherein the applying of said optimization factors in at least one of: capacity, scoring, workload, and availability of said organizational resources.

13. The system according to claim 12, wherein the scoring is calculated by assessing the performance of the organizational resource by monitoring a behavior thereof.

14. The system according to claim 12, wherein the workload is calculated by assessing the work in process of the organizational resource by monitoring a behavior thereof.

15. A non-transitory computer readable medium for automatically optimizing work item allocation to organizational resources using a computerized delivery management system (DMS), said non-transitory computer readable medium comprising a set of instructions that when executed cause at least one computer processor to:
obtain a stream of work items allocation requests from the DMS;
analyze the stream of work items allocation requests, to extract work items specification from the requests;
apply an optimization of the organizational resources in view of the work items specifications; and
provide recommendation for allocation or performing automatic allocation of said work items to the DMS.

16. The non-transitory computer readable medium according to claim 15, wherein said organizational resources comprise at least one of: a human, a team of humans, one or more robots.

17. The non-transitory computer readable medium according to claim 15, wherein said stream of work items allocation requests comprises at least one of: documents, emails, messages, sent between the organizational resources.

18. The non-transitory computer readable medium according to claim 15, wherein extracting the work item specification is carried out by applying natural language processing.

19. The non-transitory computer readable medium according to claim 15, wherein the applying of said optimization factors in at least one of: capacity, scoring, workload, and availability of said organizational resources.

20. The non-transitory computer readable medium according to claim 19, wherein the scoring is calculated by assessing the performance of the organizational resource by monitoring a behavior thereof.
